(19) United States
(12) Patent Application Publication
(10) Pub. No.: US 2016/0152112 A1
(43) Pub. Date: Jun. 2, 2016

(54) SOLAR-POWER SYSTEM AND CONTROL FOR VEHICLE AIR CONDITIONING SYSTEM

(71) Applicants: Rick R. Stetler, Glasford, IL (US); Greg A. Wall, Glasford, IL (US); Megan Wall, Glasford, IL (US)

(72) Inventors: Rick R. Stetler, Glasford, IL (US); Greg A. Wall, Glasford, IL (US); Megan Wall, Glasford, IL (US)

(21) Appl. No.: 14/953,583

(22) Filed: Nov. 30, 2015

Related U.S. Application Data
(60) Provisional application No. 62/086,257, filed on Dec. 2, 2014.

(51) Int. Cl. B60H 1/00; B60H 1/32; B23P 19/00

(52) U.S. Cl. CPC B60H 1/00428; B23P 19/00; B60H 1/0075; B60H 1/3222; B60H 1/3208; B60H 1/322; B60H 1/00985

(57) ABSTRACT

A solar power system and control for a vehicle with an air conditioning system includes a solar panel unit, a voltage regulator, an electric drive motor, a user interface, and a thermostat controller. The solar panel unit is mounted on the vehicle. The voltage regulator is electrically connected to the solar panel unit and a power storage device of the vehicle. The electric drive motor is mounted to the vehicle and drivingly connected to a compressor of the air conditioning system. The user interface includes a system activate user input device configured to generate and transmit a system activate signal. The thermostat controller is communicatively connected to the user interface to receive the system activate signal; and configured to selectively provide electric power to the electric drive motor, the condenser fan electric motor, and the blower fan electric motor, at least in part, in response the activate system signal.

### PRIORITY

This application claims priority to and incorporates by reference in its' entirety, U.S. Provisional Patent Application No. 62/086257, entitled “Solar-Powered Vehicle Air Conditioning System”, and filed Dec. 2, 2014.

### TECHNICAL FIELD

The present invention generally relates to solar-powered vehicle air conditioning systems, and more particularly to solar-powered vehicle air conditioning systems for maintaining a cool temperature in a vehicle with or without the vehicle motive power source running.

### BACKGROUND OF THE INVENTION

The present invention generally relates to apparatus and methods for treatment of airstreams in an Environmental Control System (ECS) to remove particles using an aircraft electronic particle separation system.

During hot summer months, an average passenger vehicle may spend up to sixty percent of its parked time in the hot sun. Passenger vehicles are often parked without proper ventilation, and the heat from sunlight can cause the interior temperature of the vehicle to reach temperatures above 150 degrees Fahrenheit (150° F.). When drivers return to their parked cars, they may experience considerable discomfort due to the high temperature until the air conditioning cools the interior of the vehicle within comfortable ranges. Many drivers may desire to leave children or pets in the safety of a car, however, during warm weather the parked vehicle's interior may reach temperatures that may be unsafe for children and/or animals. In some situations, vehicle passengers may desire to stay in a parked vehicle but are unable to because the interior temperature is to hot. For example, some drivers may prefer to return to their vehicle during work breaks. However, it may not be possible to cool the vehicle to a comfortable temperature during the duration of the break.

As can be seen, there may be an ongoing need to control the temperature of the interior of a vehicle while its' engine or other motive power source is not running.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

In one aspect of the present invention, a solar power system and control for a vehicle with an air conditioning system includes a solar panel unit, a voltage regulator, an electric drive motor, a user interface, and a thermostat controller. The vehicle includes a power storage device, and the air conditioning system with a compressor, a condenser with a condenser fan electric motor, and a blower fan with a blower fan electric motor. The solar panel unit is mounted on the vehicle and configured to convert solar energy to DC electric power. The voltage regulator is electrically connected to the solar panel unit and the power storage device, and configured to convert the DC electric power from the solar panel unit to electric power at a predefined DC voltage, and supply the electric power at the predefined voltage to the power storage device to charge the power storage device. The electric drive motor is mounted to the vehicle and drivingly connected to the compressor. The user interface has a system activate user input device and is configured to generate and transmit a system activate signal. The thermostat controller is electrically connected to receive electric power from the power storage device, and selectively electrically connected to provide electric power to the electric drive motor, the condenser fan electric motor, and the blower fan electric motor. The thermostat controller is communicatively connected to the user interface to receive the system activate signal; and configured to provide electric power to the electric drive motor, the condenser fan electric motor, and the blower fan electric motor, at least in part, in response the activate system signal.

In another aspect of the present invention, a vehicle air conditioning solar power and control system for installation on a vehicle with an air conditioning system includes a solar panel unit, a voltage regulator, an electric drive motor, a user interface, and a thermostat controller. The vehicle includes a power storage device, and the air conditioning system including a compressor, a condenser with a condenser fan electric motor, and a blower fan with a blower fan electric motor. The solar power unit is configured to be mounted on the vehicle, and to convert solar power to DC electric power. The voltage regulator is configured to be mounted on the vehicle, to be electrically connected to the solar power unit, to convert the DC electric power from the solar power unit to electrical power at a predefined voltage, and to be electrically connected to the power storage device to charge the power storage device. The electric drive motor is configured to be mounted on the vehicle and drivingly connected to the compressor. The user interface includes a system activate user input and is configured to generate and transmit a system activate signal. The thermostat controller includes a power interface with a battery input port, an electric drive motor output port, a condenser fan electric motor output port, and a blower fan electric motor output port; and is configured to electrically connect to the power storage device to receive electric power from the power storage device through the power storage device input port. The thermostat controller is also configured to electrically connect to the electric drive motor through the electric drive motor output port to selectively provide electric power from the power storage device to the electric drive motor; and electrically connect to the condenser fan electric motor through the condenser fan electric motor output port to selectively provide electric power from the power storage device to the condenser fan electric motor. The thermostat controller is additionally configured to electrically connect to the blower fan electric motor through the blower fan electric motor output port to selectively provide electric power from the power storage device to the blower fan electric motor; communicatively connect to the user interface to receive the system activate signal; and electrically connect the power storage device input port to the electric drive motor output port, the condenser fan electric motor output port, and the blower fan electric motor output port, at least in part, in response the activate system signal.

In yet another aspect of the present invention, A method of installing a vehicle air conditioning solar power and control system on a vehicle, the air conditioning system including a compressor, a condenser with a condenser fan electric motor, and a blower fan with a blower fan electric motor, the vehicle including a power storage device is disclosed. The method includes disconnecting the compressor from a motive power source of the vehicle; mounting an electric drive motor, a solar power unit including a voltage regulator, and a thermostat controller to the vehicle; the solar power unit configured to convert solar energy to DC electric power at a predefined voltage; the thermostat controller including a power interface with a battery input port, an electric drive motor output port, a condenser fan electric motor output port, and a blower fan electric motor output port; and drivingly connecting the electric drive motor to the compressor. The method also includes electrically connecting the solar power unit to the power storage device; electrically connecting the power storage device input port to the power storage device; and electrically connecting the compressor output port to the electric drive motor. The method further includes electrically connecting the condenser fan electric motor output port to the condenser fan electric motor; and electrically connecting the blower fan electric motor output port to the blower fan electric motor. The thermostat controller is configured to electrically connect the battery input port to the electric drive motor output port, the condenser fan electric motor output port, and the blower fan electric motor output port, at least in part, in response to a system activate signal received from a user interface.

These and other features, aspects and advantages of the present invention will become better understood with reference to the following drawings, description and claims.

### BRIEF DESCRIPTION OF THE DRAWINGS

FIG. 1 is a perspective and schematic view of a vehicle with a solar power and control system, according to an exemplary embodiment of the present invention.

FIG. 2 is a schematic view of a solar power and control system connected to an air conditioning system, according to an exemplary embodiment of the present invention.

FIG. 3 is a front view of a user interface, according to an exemplary embodiment of the present invention.

FIG. 4 is a schematic view of a power interface, according to an exemplary embodiment of the present invention.

FIG. 5A is a flow chart of a first portion of a method of installing a vehicle air conditioning solar power and control system on a vehicle, according to an exemplary embodiment of the present invention.

FIG. 5B is a flow chart of a second portion of the method of installing a vehicle air conditioning solar power and control system on a vehicle of FIG. 5A, according to an exemplary embodiment of the present invention.

FIG. 6A is a flow chart of a first portion of a method of controlling a vehicle air conditioning system with a solar power and control system, according to an exemplary embodiment of the present invention.

FIG. 6B is a flow chart of a second portion of the method of controlling a vehicle air conditioning system with a solar power and control system of FIG. 6A, according to an exemplary embodiment of the present invention.

FIG. 7A is a flow chart of a first portion of a method of controlling a vehicle air conditioning system with a solar power and control system with a user interface, according to an exemplary embodiment of the present invention.

FIG. 7B is a flow chart of a second portion of the method of controlling a vehicle air conditioning system with a solar power and control system with a user interface of FIG. 7A, according to an exemplary embodiment of the present invention.

FIG. 7C is a flow chart of a third portion of the method of controlling a vehicle air conditioning system with a solar power and control system with a user interface of FIGS. 7A and 7B, according to an exemplary embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above, or may only address one of the problems discussed above. Further, one or more of the problems discussed above may not be fully addressed by any of the features described below.

To meet the needs described above and others, the present disclosure provides a solar power and control system for a vehicle air conditioning system. The system may be installed aftermarket or may come pre-installed on a vehicle. The system is powered independently of the motive power source of the vehicle, and may power and control the air conditioning system of the vehicle while the motive power source is not running. The system may thus power the vehicle air conditioning system while the vehicle is parked and the motive power source, which may be an internal combustion engine, is off.

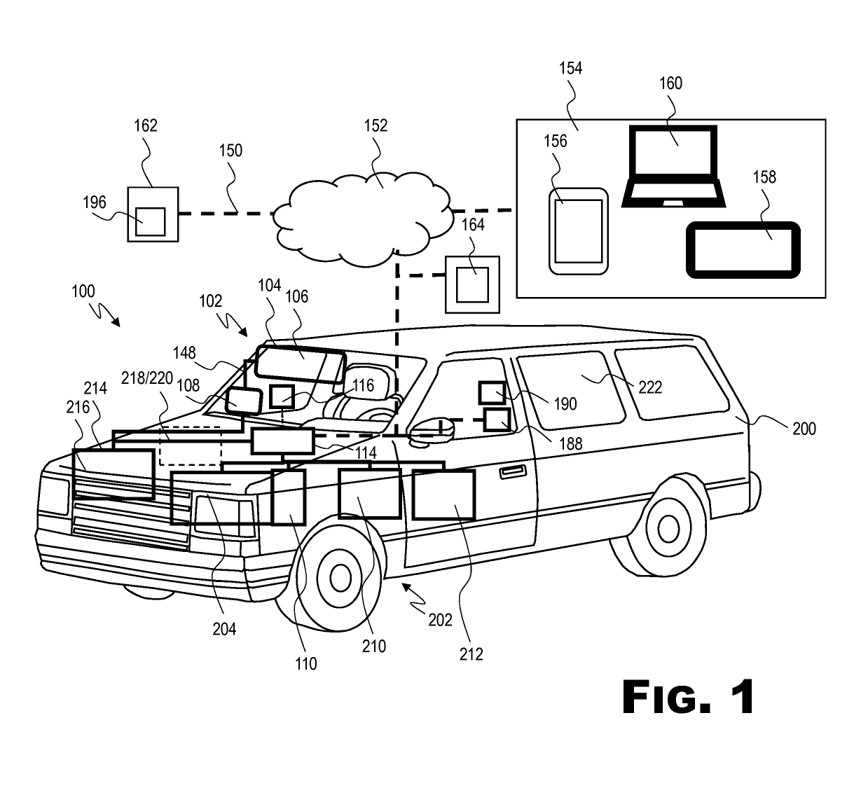

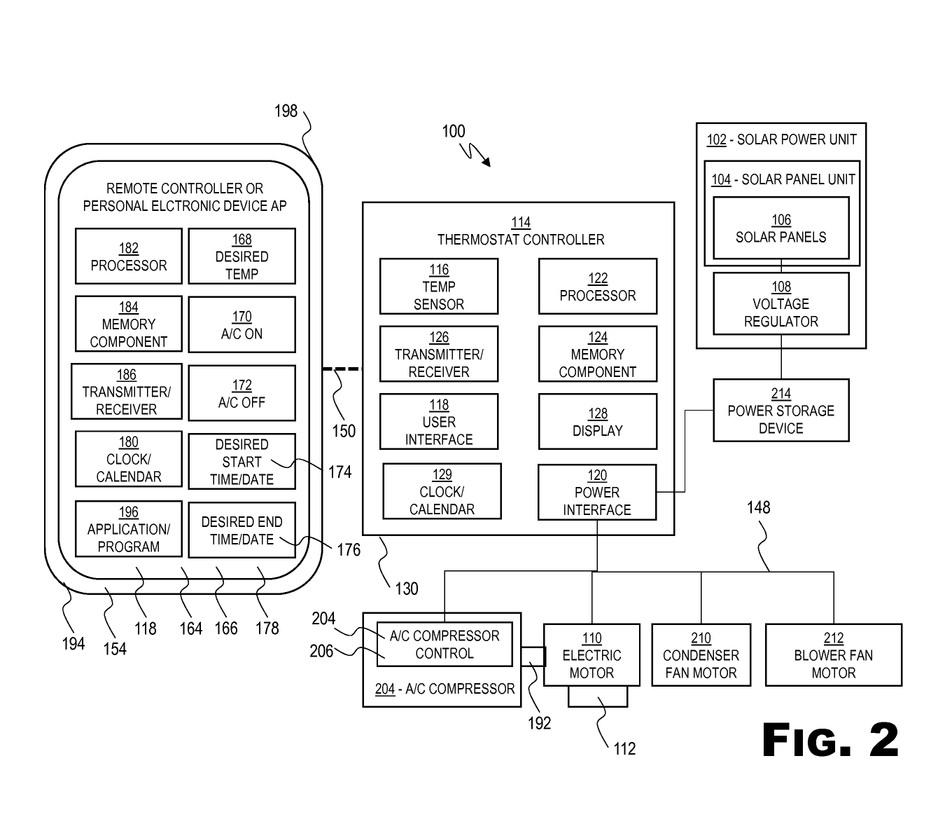

Referring now to FIGS. 1-2, an exemplary vehicle 200 with an exemplary solar power and control system 100 is illustrated in perspective and schematic views. In FIGS. 1-2, components of the system 100 are generally numbered with 100 series element numbers, while components of the vehicle 200 are generally numbered with 200 series element numbers. The vehicle 200 will be described first, including traditional configuration of the air conditioning system 202, such that the interfaces with the system 100, and how the system 100 may be retrofitted onto the vehicle 200 may be more fully understood.

The vehicle 200 is illustrated as a sports utility vehicle, but may take many different forms. Non-limiting examples include automobiles, farm tractors, combines, semi-trucks, bulldozers, backhoes, trackhoes, cranes, heavy equipment, refrigerated semi-trailers, motor homes, enclosed utility trailers, concession trailers, ambulances, rescue vehicles, buses, and limousines. The vehicle 200 may include an air conditioning system 202, a power storage device 214, a motive power source 218, and an interior 222. The air conditioning system 202 may include a compressor 204, a condenser fan electric motor 206, and a blower fan electric motor 208. The compressor 204 may include a compressor control 206, such as a pressure switch 208 which actuates and engage the clutch. The power storage device 214 may include a battery 216. The motive power source 218 may include an internal combustion engine 220.

Traditionally, compressors 204 are powered by the motive power source 218 through a power take-off such as a belt drive. The belt drive may drive the compressor 204 when a clutch is engaged. The clutch may be engaged through an electronic control powering a pressure switch 208. The electric power for the control may be provided from the power storage device 214, which may be charged with an alternator. The alternator may be powered with a power take-off from the motive power source 218. Other electronic controls 206 may also be used to control the compressor 204 as are known in the art. The compressor 204 may comprise a driven pump configured to draw in refrigerant in a low-pressure gaseous form. Once the gas is inside the pump, the compressor may put the gas under pressure and force the gas out to a condenser (not shown).

The condenser may include a condenser fan (not shown) which may be driven by the condenser fan electric motor 210. The condenser fan electric motor 210 may traditionally be selectively electrically connected to the power storage device 214 through an electronic control as is known in the art. The condenser may comprise a heat exchanger, and may draw heat out of the air conditioning system 202. Refrigerant may enter the condenser as a pressurized gas from the compressor 204. The process of pressurizing the gas and moving it to the condenser may create heat. The condenser may include twisted tubes or other heat exchanger elements through which the gas flows. The condenser fan may create air may flow around the twisting tubes and cool the refrigerant until it forms a liquid. The condenser fan electric motor 210 may drive the fan. The condenser may produce high pressure liquid refrigerant to cool the car.

The refrigerant may then flow through a receiver/dryer unit to remove any water from the refrigerant and into a thermal expansion valve or orifice tube. The thermal expansion valve may allow the high pressure liquid refrigerant to expand, reducing the pressure on the refrigerant, and flow into an evaporator. The valve may sense pressure and regulate the flow of refrigerant, allowing the air conditioning system 202 to operate steadily. Alternatively, the orifice tube may allow the refrigerant to flow at a constant rate.

The refrigerant may flow into an evaporator which may absorb heat and cool the interior 222 of the vehicle 200. The evaporator may be located in the interior 222 and comprise a heat exchanger. The evaporator may include coils of tubes and/or fins. The blower fan may blow air over the evaporator and into the interior cooling the air and transferring heat into the refrigerant. The blower fan may be powered by the blower fan electric motor 212. The blower fan electric motor 212, in a traditional configuration, may be selectively electrically connected to the battery 216. The connection to the battery 216 may be controlled by the vehicle control system. The battery 216 may be charged with an alternator driven by the motive power source 218.

The power storage device 214 may include any device which may receive electric power, store the electric power, and transmit the electric power to where it is needed. The power storage device 214 may comprise a battery 216, and the battery 216 may comprise a 12V battery. In other embodiments, the power storage device 214 may include super capacitors or other suitable power storage devices. In this description the power storage device 214 may sometimes be referred to as the battery 216. It should be understood that if another power storage device 214 might be suitably substituted then the term battery 216 should encompass that power storage device 214 as well.

The system 100 may be configured to replace the motive power source 218 as the power source for the air conditioning system 202. Additionally the system 100 may replace air conditioning system 202 controls in the vehicle control system, allowing the air conditioning system 202 to be controlled independently of the vehicle 200. The system 100 includes a solar panel unit 104, a voltage regulator 108, an electric drive motor 110, a user interface 118, and a thermostat controller 114. The solar panel unit 104 is mounted on the vehicle 200 and configured to convert solar energy to DC electric power. The voltage regulator 108 is electrically connected to the solar panel unit 104 and the power storage device 218, and configured to convert the DC electric power from the solar panel unit 104 to electric power at a predefined DC voltage, and supply the electric power at the predefined voltage to the power storage device 218 to charge the power storage device 218. The electric drive motor 110 is mounted to the vehicle 200 and drivingly connected to the compressor 204. The user interface 118 includes a system activate user input device 170 configured to generate and transmit a system activate signal. The thermostat controller 114 is electrically connected to receive electric power from the power storage device 214, and selectively electrically connected to provide electric power to the electric drive motor 110, the condenser fan electric motor 210, and the blower fan electric motor 212. The thermostat controller 114 is communicatively connected to the user interface 118 to receive the system activate signal. The thermostat controller 114 is configured to provide electric power to the electric drive motor 110, the condenser fan electric motor 210, and the blower fan electric motor 212, at least in part, in response the activate system signal.

The solar panel unit 104 may include solar panels 106. The solar panels 106 may include panels designed to absorb the sun's rays as a source of energy for generating DC electricity. The solar panels 106 may convert the solar energy to DC electric current through the photovoltaic effect. In the embodiment illustrated in FIG. 1, the solar panel unit 104 is mounted on a top portion of the vehicle 200 windshield on the passenger side of the vehicle 200. In other embodiments, the solar panel unit 104 may be mounted on the exterior of the windshield. This may permit greater power absorption from sunlight by preventing filtering of light frequencies by the windshield glass. In some embodiments, the solar panel unit 104 may include a movable sheet of solar panels 106 (such as flexible panels) that may be lowered to fill a significant portion of the windshield area. This permits increased power absorption while also diminishing the amount of sunlight permitted to enter the cabin and cause warming. The solar panel unit 104 may be electrically connected to the voltage regulator 108 through a power connector 148. In general, power connectors 148 are illustrated as solid lines in the Figures, and communicative connectors 150 are illustrated as dashed lines.

The voltage regulator 108 may be mounted on the vehicle. In some embodiments, the solar panel unit 104 and the voltage regulator 108 may comprise one integral solar power unit 102. Solar power units 102 are available commercially. The voltage regulator 108 may include a device designed to automatically maintain a constant voltage level. The voltage regulator 108 may be a simple “feed-forward” design or may include negative feedback control loops. The voltage regulator 108 may include an electromechanical mechanisms, and/or electronic components. The DC electric power generated by the solar panels 106 may have a varying voltage. The voltage regulator 108 may convert the varying voltage electric power to DC electric power with a predetermined steady voltage. The predetermined voltage may be twelve volts (12V) when the power storage device 214 comprises a 12V battery such as is common in most vehicles. In some embodiments the voltage regulator 108 may be adjustable. In some embodiments the solar panel unit 104 may be electrically connected to the voltage regulator 108 through wires passing through the frame at the windshield and going into an engine compartment of the vehicle 200 where the voltage regulator 108 may be mounted.

The voltage regulator 108 may be electrically connected through power connection 148 to the power storage device 214 to charge the power storage device 214. In many embodiments the power storage device 214 includes the battery 216, and one method of electrically connecting the voltage regulator to the battery 216 is through a cigarette lighter interface available in most vehicles 200. In other embodiments wires may be routed under coverings in the interior 222 and through openings to the engine compartment and the power storage device 218.

The electric drive motor 110 may include any DC motor configured to operate with ratings consistent with receiving input power from the power storage device 218, and having power output ratings high enough to drive the compressor 204 consistent with the air conditioning system 202 specifications. The electric drive motor 110 may be mounted to the vehicle with a bracket 112, or other means known in the art, in a position to be drivingly connected to the compressor. When the system 100 is installed aftermarket, the drive connection from the motive power source 218 may be removed and then the electric drive motor may be connected. The connection may be through a mechanical coupling 192 such as a belt, a shaft connection, or any other connection which transfers rotational power from the electric drive motor 110 to the compressor 204. The electric drive motor 110 may be selectively electrically connected to the power storage device 214 through a power connector 148 connected to between the electric drive motor 110 and an electric drive motor output port 138 of a power interface 120 of the thermostat controller 114.

The system 100 may include a temperature sensor 116 configured to be mounted in the interior 222 of the vehicle 200. The temperature sensor 116 may be configured to generate a vehicle temperature signal indicative of a vehicle interior temperature. The temperature sensor 116 may be communicatively connected to the thermostat controller 114 to transmit the vehicle temperature signal to the thermostat controller 114. In one embodiment, as illustrated in FIG. 2, the temperature sensor 116 may be integral to the thermostat controller 114.

The system 100 may include a vehicle temperature display 188 configured to be mounted on a window of the vehicle 200 in the interior 222. The vehicle temperature display 188 may be communicatively connected with the thermostat controller 114 to receive the vehicle temperature signal. The vehicle temperature display 188 may include a display, and may display the interior 222 temperature on the display. In another embodiment the vehicle temperature display 188 may be a stand-alone thermometer. The vehicle temperature display 188 allows a person who sees a pet or a person in the vehicle 200, when the vehicle 200 is parked, and is concerned because of high temperatures to see that the interior 222 is at a safe and comfortable temperature.

The system 100 may include a system identifier 190 configured to be mounted on a window or another part of the vehicle 200 where a person outside the vehicle 200 may see it. The system identifier 190 informs a person that the vehicle 200 has the system 100. The system identifier 190 may, for example, be a decal.

The user interface 118 may allow a user to control the system 100 through entering commands through input devices, and receiving information from through displays. The user interface 118 may take a variety of forms. In one embodiment, the user interface 118 may be integral to the thermostat controller 114 and may be integrated into a housing 130 of the thermostat controller 114. In another embodiment, the user interface may be a component of a remote control device 164 communicatively linked to the thermostat controller 114 through a short range communication link. In another embodiment the user interface 118 may comprise an application program stored on a personal electronic device 154, or viewed through a program such as a browser from a third party server 162 on the personal electronic device. The personal electronic device 154 may comprise, for example, a mobile phone 156, a mobile electronic tablet 158, and/or a computer 160. The user interface 118 is not confined to only one embodiment, and one, all, or some of these examples may be used to send commands and/or programming information to the thermostat controller 114. In other embodiments, the user interface 118 may comprise a voice activated system through a telephone connection, or any other user interface 118 as would be known in the art.

When the user interface 118 is viewed and interacted with through the personal electronic device 154, the personal electronic device 154 may be communicatively linked to the thermostat controller 114 through a communication network 152 and/or the third party server 162. The network 152 may comprise the wide area networks (WAN) such as the Internet, cellular networks, and/or satellite networks; and/or local area networks (LAN) such as a wireless Internet or cellular connector. The third party server 162 may include servers from which an application 196 could be downloaded such as the Apple® store or the Google® playstore. The third party server 162 may also include a server hosting an interactive website with the user interface 118.

In the embodiment where the user interface 118 is part of an interactive website, the server may run software which allows a user to create an account which identifies the user with a particular thermostat controller 114. The thermostat controller 114 may include an IP address, a cellular number, a satellite connection or any other identifier which allows data meant for transmission to that particular thermostat controller 114 to be received by that thermostat controller 114. Applications 166 downloaded to the personal electronic device 154 which include the user interface 118 may also communicate with the thermostat controller 114 through the third party server 162 in a similar manner.

In some embodiments, an application downloaded to the personal electronic device 154 may allow the personal electronic device to communicate directly with the thermostat controller 114. For example, when the thermostat controller 114 includes a cellular number or satellite link associated solely to a particular thermostat controller 114, a mobile phone 156 may directly communicate through cellular or satellite link with the thermostat controller 114.

An exemplary device 198 with a housing 194 and a user interface 118 is illustrated in FIG. 2. The device 198 may comprise a personal electronic device 154 or a remote control device 164. If the device 198 is a personal electronic device 154, the device 198 may be running, and have stored in a memory component 184, a personal electronic device application 196, and may be displaying a screen 166 from the application 196. The user interface 118 may include an interactive touchscreen 178 as is known in the art. The device 198 may include a processor 182 and memory component 184 for storing software code, and executing software code respectively as is known in the art. The device 198 may include a transmitter/receiver unit to receive signals from and transmit signals to other devices including the thermostat controller 114 and/or the third party server 162. The device 198 may include a clock/calendar 180 for coordinating with other devices. The user interface 118 may include a desired temperature input device 168 for entering a desired temperature. The device 198 may generate and transmit to the thermostat controller 114 a desired temperature signal indicative of the desired temperature. The desired temperature may include a desired temperature range, a desired minimum temperature, and/or a desired maximum temperature. The user interface 118 may include a system activate input device 170 for a user to input a system activate command. The device 198 may generate and transmit to the thermostat controller 114 a system activate signal in response to the system activate input. The user interface 118 may include a system deactivate input device 172 for a user to input a system deactivate command. The device 198 may generate and transmit to the thermostat controller 114 a system deactivate signal in response to the system deactivate input. The user interface 118 may include a desired start time/date input device 174 and a desired end time/date input device 176 for a user to input programming instructions. The device 198 may generate and transmit to the thermostat controller 114 programming information in response to the programming instructions input.

The thermostat controller 114 may receive commands and/or programming information from the user interface 118, and the vehicle temperature signal from the temperature sensor 116, and may control the system 100 in response to these signals and information. The thermostat controller 114 may include the temperature sensor 116 and/or the user interface 118. The thermostat controller 114 may include a housing 130 and be configured for mounting in the interior 222 of the vehicle 200.

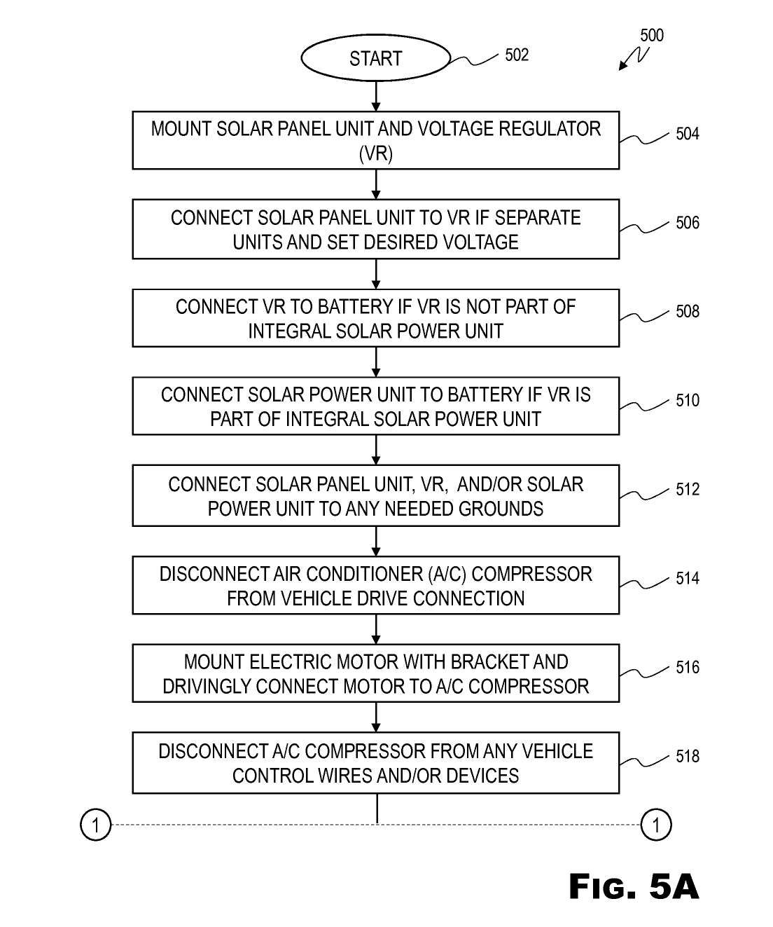

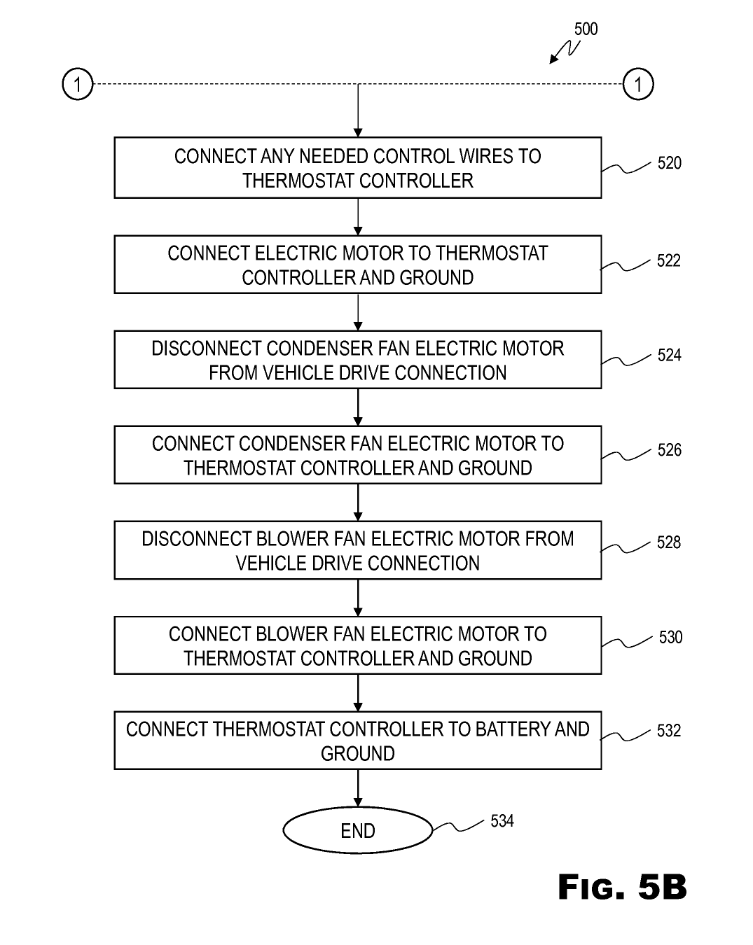

An exemplary thermostat controller 114 is illustrated in FIG. 2. The embodiment illustrated includes the temperature sensor 116 and the user interface 118. The thermostat controller 114 may include a processor 122 for executing computer code to implement one or more methods as illustrated and described in relation to FIGS. 5A, 5B, 6A, 6B, 7A, 7B, and/or 7C. The computer code may be stored in a memory component 124 or provided to the processor through other computer readable media. The processor 122 may execute computer code which causes the thermostat controller to selectively electrically connect the power storage device 214 with the compressor 204, the compressor control 204, the pressure switch 206, the electric drive motor 110, the condenser fan electric motor 210, and/or the blower fan electric motor 212. The processor 122 may cause thermostat controller 114 to selectively make the above connections in response to one or more of the vehicle temperature signal, the desired temperature signal, the system activate signal, the system deactivate signal, and the programming information.

The thermostat controller 114 may include a display 128 for displaying various information to a user, and a clock/calendar 129 for reference in implementing programming information. The thermostat controller 114 may include a power interface 120 for selectively making electrical connections.

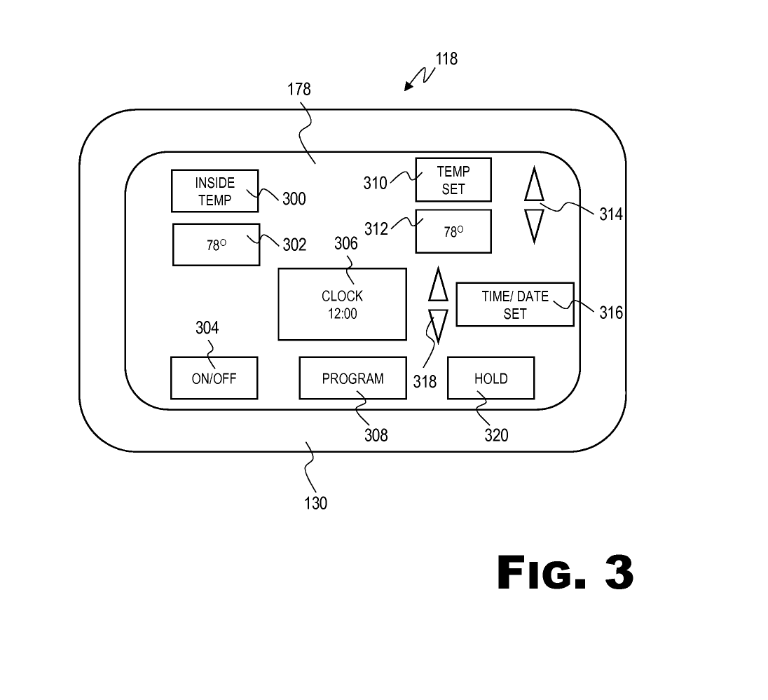

Referring now to FIG. 3, an exemplary embodiment of a user interface 118 that may be integral to the thermostat controller 114 is illustrated. In one of the simplest embodiments, the user interface 118 may be incorporated into the housing 130 of the thermostat controller 114. A user may be able to access it from the interior 222. The user interface 118 may include an interactive touchscreen 178 including a vehicle temperature text label 300, a vehicle temperature display 302, an on/off button 304, a clock and programming display 306, a program start and set button 308, a desired temperature text label 310, a desired temperature display 312, a temperature setting input 314, a desired date/time range text label 316, a desired date/time range input 318, and a hold temperature button 320.

The vehicle temperature text label 300 may include text indicating that the temperature displayed in the vehicle temperature display 302 is the current temperature in the interior 222. The vehicle temperature display 302 may display the temperature in the interior 222 as indicated by the temperature sensor 116. The on/off button 304 may comprise the system activate input 170 and the system deactivate input 172. When moved to the on position, the user interface 118 may transmit the system activate signal. When moved to the off position the user interface may transmit the system deactivate signal. The clock and programming display 306 may as a default display the current time and/or date. When a user desires to input programming instructions, the display 306 may display menu and setting choice for the user to select using the program start and set button 308, the temperature setting input 314, and/or the desired date/time range input 318. The program start and set button 308 may be used by a user to begin inputting programming instructions and selecting menu and setting choices in conjunction with the display 306. The desired temperature text label 310 may include text indicating that the temperature displayed in the temperature display 312 is the current selected desired temperature. The desired temperature display 312 may display the current desired temperature. The temperature setting input 314 may be utilized by a user to input a desired temperature. The desired date/time range text label 316 may include text indicating that the desired date/time range input 318 may be used to input a desired date/time range. The desired date/time range input 318 may be utilized by a user to input a desired date/time range. The hold temperature button 320 may be utilized by a user to input the temperature displayed in the vehicle temperature display 302 as the desired temperature.

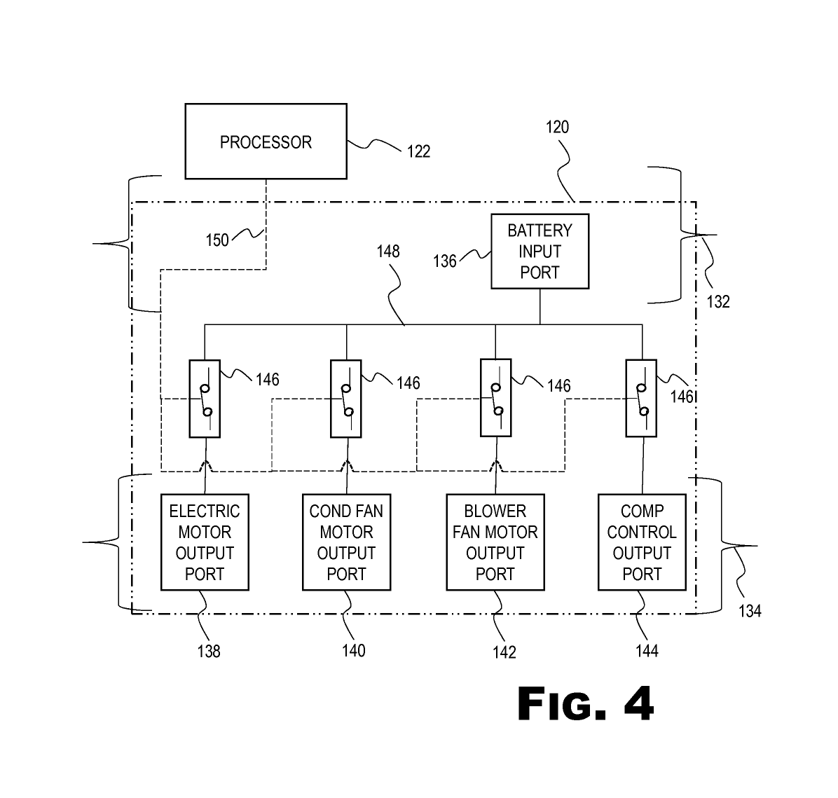

Referring now to FIG. 4, a schematic view of an exemplary embodiment of the power interface 120 is illustrated along with the processor 122 and the processor 122 connections to the power interface 120. The components of the power interface 120 are indicated by the dahs and two dots border. The power interface 120 may include power input ports 132, power output ports 134, switch units 146, and power connectors 148. The processor 122 may be communicatively and operatively connected to the switch units 146 to open and close the switch units 146. The power input ports 132 may include the battery input port 136. The battery input port 136 may be configured to be electrically connected to the power storage device 214, which may include the battery 216. The power output ports 134 may include the electric drive motor output port 138, the condenser fan electric motor output port 140, the blower fan electric motor output port 142, and the compressor control output port 144. The electric drive motor output port 138 may be configured to be electrically connected to the electric drive motor 110. The condenser fan electric motor output port 140 may be configured to be electrically connected to the condenser fan electric motor 210. The blower fan electric motor output port 142 may be configured to be electrically connected to the blower fan electric motor 212. The compressor control output port 144 may be configured to be electrically connected to the compressor control 206. At least in part, in response to the desired temperature signal, the vehicle temperature signal, the system activate signal, the system deactivate signal, and programming instructions, the processor 122 may transmit a signals opening and closing the switch units 146. In one embodiment the switch units 146 may be open in the default position. When the processor 122 sends the close signal electric power may flow from the power storage device 214, through the battery input port 136, through the switch units 146, through the output ports 134, and to the electric drive motor 110, the condenser fan electric motor 210, the blower fan electric motor 212, and the compressor control 206. When this happens, the pressure switch 208 may engage the clutch, the electric drive motor 110 may drive the compressor 204, the condenser fan electric motor 210 may drive the condenser fan, the blower fan electric motor may drive the blower fan, and the air conditioning system 202 may cool the interior 222 of the vehicle 200 to the desired temperature.

Referring now to FIG. 5A, a first portion of a method 500 of installing the vehicle air conditioning solar power and control system 100 on the vehicle 200 is illustrated. The method 500 starts at 502. The solar panel unit 104 may be mounted on the passenger side of the windshield of the vehicle 200 or any other appropriate place on the vehicle 200 where the solar panels 106 will receive solar energy. The voltage regulator 108 may be mounted in the engine compartment of the vehicle 200 if it is a separate unit, or be mounted with the solar panel unit 104 if both are a part of a single solar power unit 102 (step 504). If the voltage regulator 108 and the solar panel unit 104 are separate units the voltage regulator 108 may be electrically connected to the solar panel unit 104 to receive DC electric power (step 506).

If the voltage regulator 108 is not part of an integral solar power unit 102, the voltage regulator 108 may be electrically connected to the battery 216 to provide DC electrical power at a predetermined voltage (which may be 12V) to the battery 216 to charge the battery 216 (step 508). If the voltage regulator 108 is part of an integral solar power unit 102, the solar power unit 102 may be electrically connected to the battery 216 to provide DC electrical power at a predetermined voltage (which may be 12V) to the battery 216 to charge the battery 216 (step 510). The solar power unit, the solar panel unit, and/or the voltage regulator 108 may be electrically connected to an appropriate ground such as the battery 216 (step 512).

The compressor 204 may be disconnected from the driving connection to the motive power source 218. This may, for example, include re-routing a belt or replacing and re-routing a belt (step 514). The electric drive motor 110 may be mounted on the vehicle 110 with a bracket 112, and drivingly connected to the compressor 204 (step 516). The compressor 204 may be disconnected from any vehicle control wires and/or devices. For example, if a pressure switch 208 is connected to the vehicle control system to engage the clutch of the compressor 204, it may be disconnected. Different vehicles 200 may have different controls 206 which may need to be disconnected (step 518). In one embodiment, the electric drive motor 110 may power the compressor 204 using a belt pulley system different from a serpentine belt which may have powered the compressor 204 with the motive power source 218. This may permit running of the air conditioning system 202 when the motive power source 218 is off without additionally powering other serpentine belt devices, such as the alternator. For such embodiments, the compressor clutch may be configured to be permanently off to permit the thermostat controller 114 to have complete control of the compressor 204. In some embodiments, the clutch may be replaced with a bearing that permits the clutch to spin freely. And, in some embodiments the electric drive motor 110 may interface with the compressor clutch directly to power the compressor 204. The method 500 continues at step 520 illustrated in FIG. 5B.

Referring now to FIG. 5B, a second portion of the method 500 of installing the vehicle air conditioning solar power and control system 100 on the vehicle 200 is illustrated. Any compressor controls 206 may be electrically connected to the thermostat controller 114. For example, if the compressor 204 includes the pressure switch 208 to engage the clutch, the pressure switch 208 may be electrically connected to the compressor control output port 140 of the power interface 120 (step 520). The electric drive motor 110 may be electrically connected to the thermostat controller 114 and a ground. For example, the electric drive motor 110 may be electrically connected to the electric drive motor output port 138 of the power interface 120, and be electrically connected to a negative terminal of the battery 216 (step 522).

The condenser fan electric motor 210 may be disconnected from the electrical power connection of the vehicle 200 (step 524). The condenser fan electric motor 210 may be electrically connected to the thermostat controller 114, through for example the condenser fan electric motor output port 140. The condenser fan electric motor 210 may be electrically connected to a suitable ground, through for example the negative terminal of the battery 216 (step 526).

The blower fan electric motor 212 may be disconnected from the electrical power connection of the vehicle 200 (step 528). The blower fan electric motor 212 may be electrically connected to the thermostat controller 114, through for example the blower fan electric motor output port 142. The blower fan electric motor 212 may be electrically connected to a suitable ground, through for example the negative terminal of the battery 216 (step 530).

The thermostat controller 114 may be electrically connected to the battery 216, through for example the battery input port 136. The thermostat controller 114 may be electrically connected to a suitable ground, through for example the negative terminal of the battery 216 (step 532). The method 500 ends at 534.

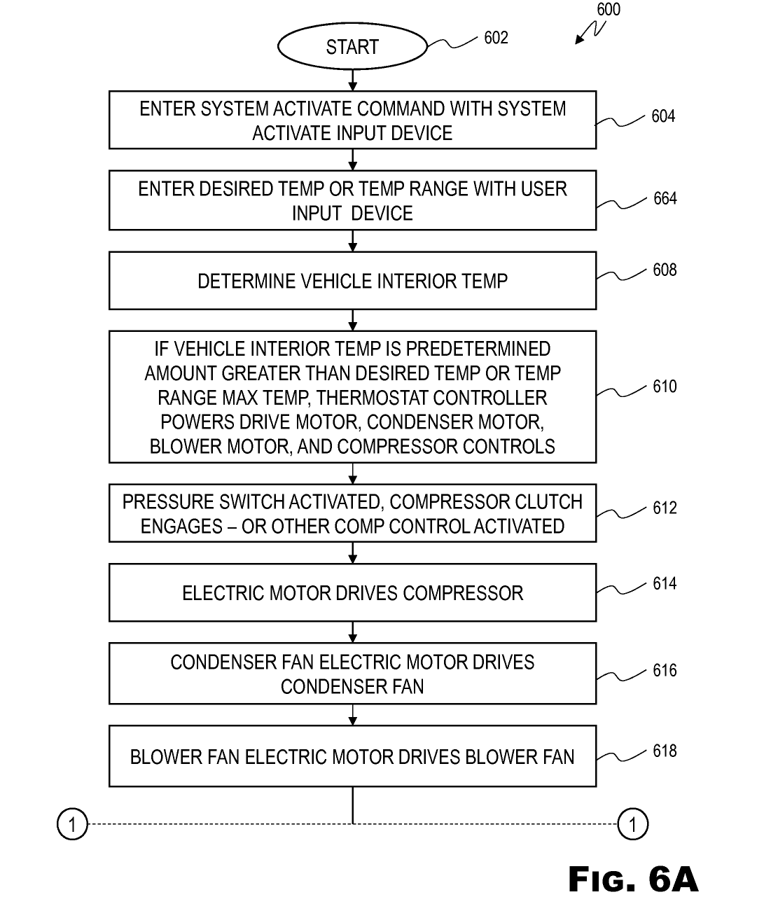

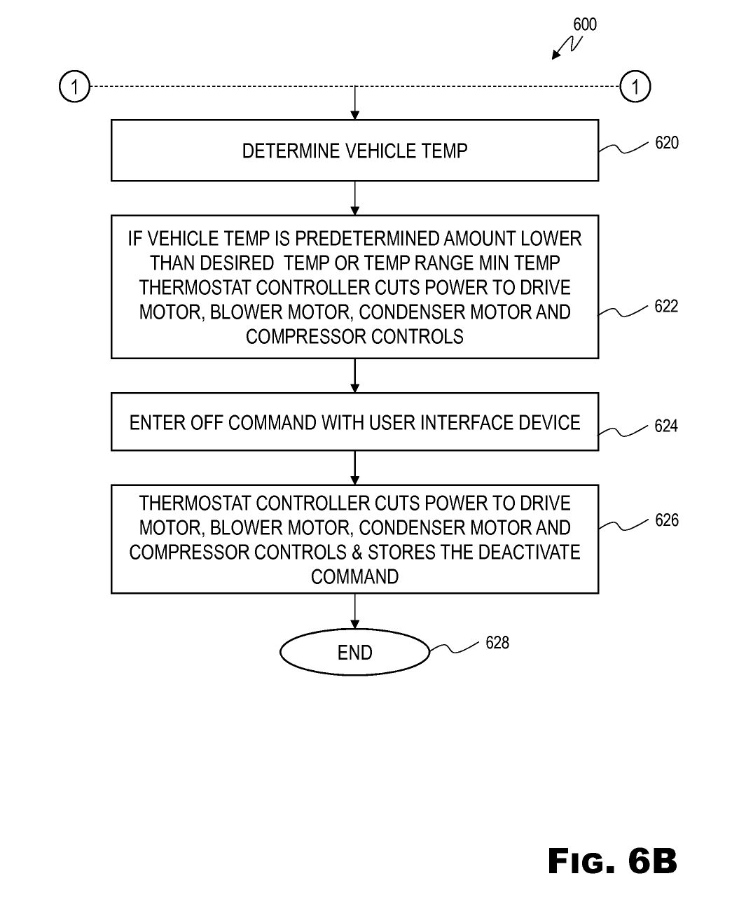

Referring now to FIG. 6A, a first portion of a method 600 of controlling the air conditioning system 202 with the solar power and control system 100 is illustrated. The method 600 begins at step 602. When a user desires to activate the air conditioning system 202, the user may enter a system activate command with the user interface 118, for example with the system activate user input device 170 (step 604). If the user desires to have the air conditioning system 202 cool the interior 222 of the vehicle 200 to a specific temperature or temperature range, the user may set a desired temperature of temperature range through the user interface 118, for example with the desired temperature input device 168. It should be understood that when a user enters a desired temperature, the thermostat controller 114 will regulate the temperature of the interior 222 of the vehicle 200 within a range around the desired temperature entered, for example within a predetermined number of degrees below and above the desired temperature. However, in some embodiments, the user may be able to enter a maximum temperature and a minimum temperature to define the regulated temperature range (step 606).

The thermostat controller 114 may determine the vehicle interior temperature, for example through the vehicle temperature signal from the temperature sensor 116 (step 608). If the vehicle interior temperature is a predetermined amount greater than the desired temperature, or the vehicle interior temperature is greater than the desired maximum temperature in the desired temperature range, the thermostat controller 114 may electrically connect the battery 216 to the electric drive motor 110, the compressor controls 206, the condenser fan electric motor 210, and the blower fan electric motor 212. For example, the processor 122 may send a signal to the switch units 146 causing the switch units 146 to close. This may electrically connect the battery input port 136 to the electric drive motor output port 138, the condenser fan electric motor output port 140, the blower fan electric motor output port 140, and the compressor control output port 142 (step 610).

If the compressor controls 206 include the pressure switch 208, the compressor clutch may engage when the pressure switch 208 is electrically connected to the battery 216. If the compressor controls 206 include other controls, these controls may be activated when electrically connected to the battery 216 (step 612). When the electric drive motor 110 is electrically connected to the battery 216, the electric drive motor 110 may drive the compressor 204 (step 614). When the condenser fan electric motor 210 and the blower fan electric motor 212 are electrically connected to the battery 216, the condenser fan electric motor 210 and the blower fan electric motor 212 may drive the condenser fan and the blower fan respectively (steps 616, 618). The method 600 continues at step 620 in FIG. 6B.

Referring now to FIG. 6B, a second portion of the method 600 of controlling the air conditioning system 100 with the solar power and control system 100 is illustrated. The thermostat controller 114 may determine the vehicle interior temperature, for example through the vehicle temperature signal from the temperature sensor 116 (step 620). If the vehicle interior temperature is a predetermined amount less than the desired temperature, or the vehicle interior temperature is less than the desired minimum temperature in the desired temperature range, the thermostat controller 114 may electrically disconnect the battery 216 from the electric drive motor 110, the compressor controls 206, the condenser fan electric motor 210, and the blower fan electric motor 212. For example, the processor 122 may send a signal to the switch units 146 causing the switch units 146 to open. This may electrically disconnect the battery input port 136 from the electric drive motor output port 138, the condenser fan electric motor output port 140, the blower fan electric motor output port 140, and the compressor control output port 142 (step 622).

A user may desire to deactivate the air conditioning system 202. For example, the weather may be cooler, the user may not expect to use the vehicle 200 for a period of time, or there may be other circumstances that cause the user to want to deactivate the air conditioning system 202. The user may enter a deactivate command through the user interface 118, for example, by making the input with the system deactivate input device 172 (step 624). If the air conditioning system 202 is running, the thermostat controller 114 may electrically disconnect the battery 216 from the electric drive motor 110, the compressor controls 206, the condenser fan electric motor 210, and the blower fan electric motor 212. The thermostat controller 114 may store the deactivate command in the memory component such that the air conditioning system 202 is not activated until an system activate command is received (step 626). The method ends at step 628.

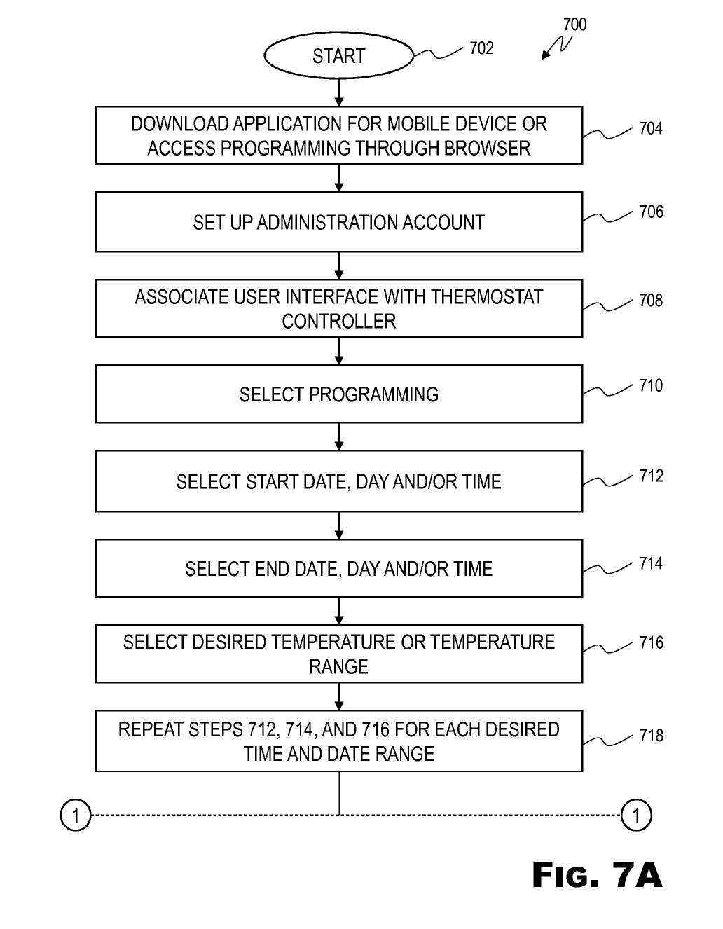

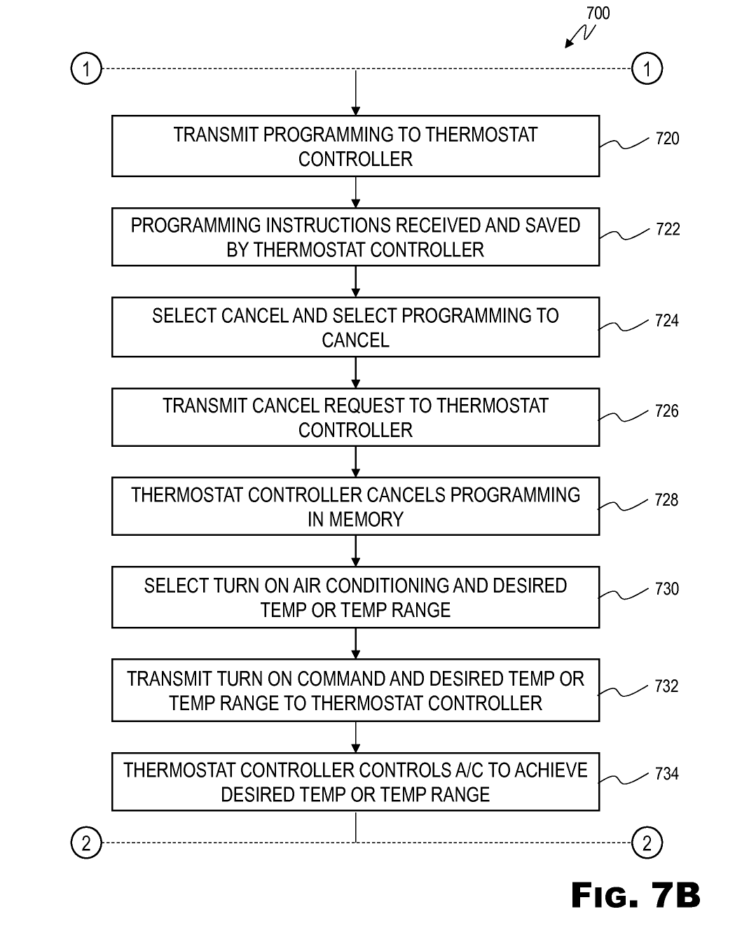

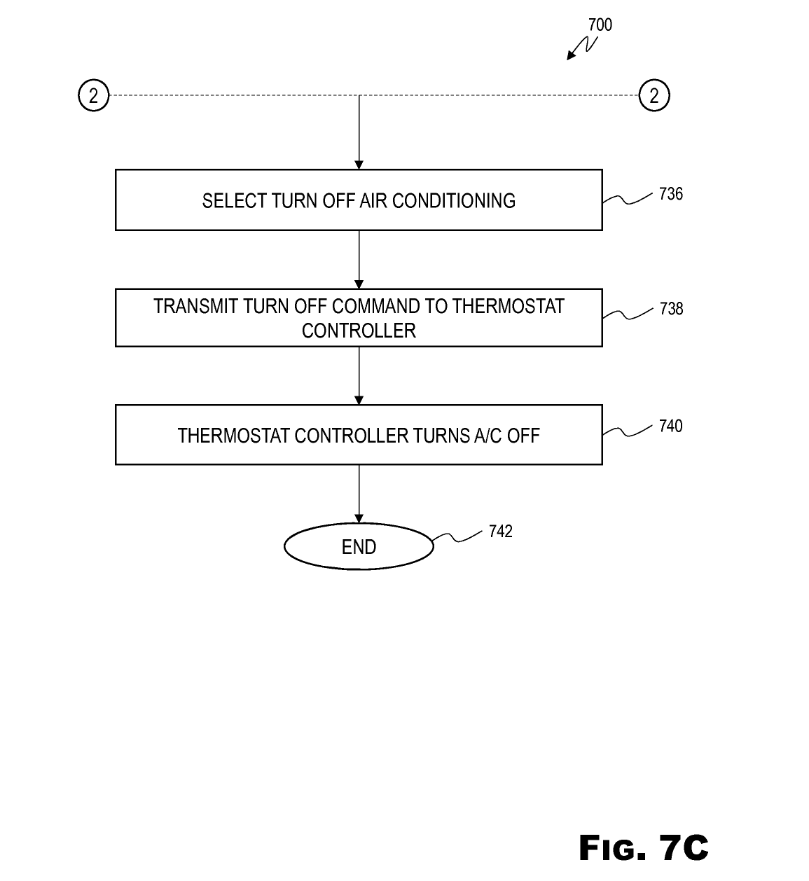

Referring now to FIG. 7A, a first portion of a method 700 of controlling the air conditioning system 202 with the solar power and control system 100 with a user interface 118 is illustrated. The method 700 begins at 702. If the user interface 118 is located on a personal electronic device 154 through an application program 196, or a website accessed through a program such as a browser, the user may download the application program 196 from the third party server or access the website hosted on the third party server 162 (step 704). The user may be required to set up a personal account with such information as is known in the art (step 706). If the user interface 118 is not integral to the thermostat controller 114, the user interface 118 may be associated with the particular thermostat controller 114 a user desires to control. This may include associating a user account and/or the personal electronic device 154 with the thermostat controller 114, or associating the remote control device 164 with the thermostat controller. There are numerous methods of implementing this which are known in the art. The association may be made through IP addresses, cellular telephone numbers or nodes, satellite communication nodes, security codes, as well as any other method known in the art. The association ensures that only users who are authorized may communicate commands and/or programming information with the thermostat controller 114 (step 708).

The user may select a programming option on the user interface 118 to program the thermostat controller to activate and/or deactivate the air conditioning system 202 at certain days, dates, and/or times. The user interface 118 may include menus, user inputs to scroll times, dates, and days, and a user input to select options. In another embodiment, such as through a website, the user interface may include fillable forms (step 710). The user may input the start date, day, or time through the user interface 118. For example, the user may indicate that starting on Monday the user desires to activate the air conditioning system at 4:45 PM, as they leave work at 5:00 PM (step 712). The user may input the end date, day, or time through the user interface. For example, the user may indicate that they want the air conditioning system to shut down at 6:00 PM and the end day is Friday. Many forms of user interfaces for application programs 196 and websites accessed through personal electronic devices 154, remote control devices 164, and user interfaces on thermostat controllers 114 are known in the art, and any which fulfill the functions contemplated may comprise the user interface 118 (step 714). The user may select the desired temperature and/or temperature range with the user interface 118, for example with the desired temperature input device 168 for the date, day, and time period (step 716). The user may repeat steps 712-716 for each period the user wishes to program the air conditioning system 202 for (step 718). The method 700 continues with step 720 in FIG. 7B.

Referring now to FIG. 7B, a second portion of the method 700 of controlling the air conditioning system 202 with the solar power and control system 100 with the user interface 118 is illustrated. The personal electronic device 154, and/or the remote control device 164 may transmit the programming instructions entered through the user interface 118 to the thermostat controller 114, and the processor 122 may store them in the memory component 124. It should be understood that transmitting commands or instructions to the thermostat controller may be done directly through a direct communication link, or indirectly through the third party server 162 and/or the communication network 152. If the user interface 118 is an integral component of the thermostat controller 114, the programming instructions may be communicated through internal communicative links to the processor 122 for storage in the memory component 124. The processor 122 may periodically execute software instructions which check the date, time, and day through, for example the clock/calendar 129 and check the programming instructions for any commands and/or instructions to activate, deactivate, or change the desired temperature. If the processor 122 determines that there are such instructions the thermostat controller 114 implements them as described in methods 500, 600 and 700 (steps 720, 722).

If a user desires to cancel programming previously entered, the user may choose a cancel option through the user interface 118, and then choose the programming to be canceled (step 724). The personal electronic device 154 and/or the remote control device 164 may transmit the cancel command and programming to be canceled to the thermostat controller 114. The processor 122 may then delete the programming instructions to be canceled from the memory component 124. If the user interface is integral to the thermostat controller 114, the processor 122 may receive the cancel command and programming to be canceled and may delete the programming instructions to be canceled from the memory component 124 (steps 726, 728).

If a user desires to turn the air conditioning system 202 on, the user may enter a system activate command through the user interface 118, for example with the system activate input device 170. The user may also enter a desired temperature through the user interface 118, for example through the desired temperature input device 168. If the user does not enter a desired temperature, the last entered desired temperature, or if never set a default desired temperature may be assumed by the user interface 118 (step 730) The system activate command and the desired temperature may be transmitted to the thermostat controller 114 (or directly to the processor if the user interface is integral to the thermostat controller 114) (step 732). The processor 122 may control the air conditioning system 202 to achieve the desired temperature as described above (step 734). The method 700 continues with step 734 in FIG. 7C.

Referring now to FIG. 7C, a third portion of the method 700 of controlling the air conditioning system 202 with the solar power and control system 100 with the user interface 118 is illustrated. If a user desires to turn the air conditioning system 202 off, the user may enter a system deactivate command through the user interface 118, for example with the system deactivate input device 172 (step 736). The system deactivate command and may be transmitted to the thermostat controller 114 (or directly to the processor if the user interface is integral to the thermostat controller 114) (step 738). The processor 122 may deactivate the air conditioning system 202 as described above (step 740). The method 700 ends at 742.

It should be understood, of course, that the foregoing relates to exemplary embodiments of the invention and that modifications may be made without departing from the spirit and scope of the invention as set forth in the following claims.

We(I) claim:

1. A solar power system and control for a vehicle with an air conditioning system, the air conditioning system including a compressor, a condenser with a condenser fan electric motor, and a blower fan with a blower fan electric motor, the vehicle including a power storage device, comprising:
a solar panel unit mounted on the vehicle and configured to convert solar energy to DC electric power;
a voltage regulator electrically connected to the solar panel unit and the power storage device, and configured to convert the DC electric power from the solar panel unit to electric power at a predefined DC voltage, and supply the electric power at the predefined voltage to the power storage device to charge the power storage device;
an electric drive motor mounted to the vehicle and drivingly connected to the compressor;
a user interface with a system activate user input device configured to generate and transmit a system activate signal; and
a thermostat controller
electrically connected to receive electric power from the power storage device, and selectively electrically connected to provide electric power to the electric drive motor, the condenser fan electric motor, and the blower fan electric motor;
communicatively connected to the user interface to receive the system activate signal; and
configured to provide electric power to the electric drive motor, the condenser fan electric motor, and the blower fan electric motor, at least in part, in response the activate system signal.

2. The solar power system and control of claim 1,
further including a temperature sensor configured to generate a vehicle temperature signal indicative of a vehicle interior temperature; and
wherein the user interface includes a desired temperature user input configured to generate and transmit a desired vehicle temperature signal indicative of a desired vehicle interior temperature; and
wherein the thermostat controller is communicatively connected to the temperature sensor to receive the vehicle temperature signal; communicatively connected to the user interface to receive the desired temperature signal; and configured to provide electric power to the electric drive motor, the condenser fan electric motor, and the blower fan electric motor, at least in part, in response the vehicle interior temperature being greater than the desired vehicle interior temperature.

3. The solar power system and control of claim 2, wherein the desired temperature signal is indicative of a minimum desired temperature and a maximum desired temperature of a desired vehicle interior temperature range.

4. The solar power system and control of claim 2, wherein:
the user interface includes a date and time range input device configured to generate a desired date and time range signal indicative of a desired date and time range during which a user desires the desired vehicle interior temperature;
the thermostat controller is communicatively connected to the user interface to receive the desired date and time range signal; and configured to provide electric power to the electric drive motor, the condenser fan electric motor, and the blower fan electric motor, at least in part, in response to the desired date and time range.

5. The solar power system and control of claim 1, wherein the thermostat controller is selectively electrically connected to provide electric power to a pressure switch configured to engage a clutch of the compressor; and configured to provide electric power to the pressure switch, at least in part, in response the activate system signal.

6. The solar power system and control of claim 1, wherein the voltage regular is configured to be electrically connected to the power storage device through a cigarette lighter connection of the vehicle.

7. The solar power system and control of claim 1, wherein the user interface is integral to the thermostat controller.

8. The solar power system and control of claim 1, wherein the temperature sensor is integral to the thermostat controller.

9. A vehicle air conditioning solar power and control system for installation on a vehicle with an air conditioning system and a power storage device, the air conditioning system including a compressor, a condenser with a condenser fan electric motor, and a blower fan with a blower fan electric motor, comprising:
a solar panel unit configured to be mounted on the vehicle, and to convert solar power to DC electric power;
a voltage regulator configured to be mounted on the vehicle, to be electrically connected to the solar panel unit, to convert the DC electric power from the solar power unit to electrical power at a predefined voltage, and to be electrically connected to the power storage device to charge the power storage device;
an electric drive motor configured to be mounted on the vehicle and drivingly connected to the compressor;
a user interface including a system activate user input configured to generate and transmit a system activate signal;
a thermostat controller including a power interface with a battery input port, an electric drive motor output port, a condenser fan electric motor output port, and a blower fan electric motor output port; and configured to
electrically connect to the power storage device to receive electric power from the power storage device through the power storage device input port,
electrically connect to the electric drive motor through the electric drive motor output port to selectively provide electric power from the power storage device to the electric drive motor,
electrically connect to the condenser fan electric motor through the condenser fan electric motor output port to selectively provide electric power from the power storage device to the condenser fan electric motor,
electrically connect to the blower fan electric motor through the blower fan electric motor output port to selectively provide electric power from the power storage device to the blower fan electric motor;
communicatively connect to the user interface to receive the system activate signal; and
electrically connect the power storage device input port to the electric drive motor output port, the condenser fan electric motor output port, and the blower fan electric motor output port, at least in part, in response the activate system signal.

10. The solar power system and control of claim 9,
further including a temperature sensor configured to generate a vehicle temperature signal indicative of a vehicle interior temperature; and being one of integral to the thermostat controller or configured to be communicatively connected to the thermostat controller to transmit the vehicle temperature signal to the thermostat controller; and
wherein the user interface includes a desired temperature user input configured to generate and transmit a desired vehicle temperature signal indicative of a desired vehicle interior temperature; and
wherein the thermostat controller is communicatively connected to the temperature sensor to receive the vehicle temperature signal; communicatively connected to the user interface to receive the desired vehicle temperature signal; and configured to provide electric power to the power output ports configured to be connected to the electric drive motor, the condenser fan electric motor, and the blower fan electric motor, at least in part, in response the vehicle interior temperature being greater than the desired vehicle interior temperature.

11. The solar power system and control of claim 9, wherein the user interface is a component of a remote control device, and the thermostat controller is configured to communicatively connect with the remote control device to receive control signals generated in response to user inputs.

12. The solar power system and control of claim 9, wherein the user interface includes an application program stored on a personal electronic device, and the thermostat controller is configured to communicatively connect with the personal electronic device through a communication network to receive control signals generated in response to user inputs.

13. The solar power system and control of claim 9, wherein the solar power unit is configured to be mounted on a portion of a windshield on the inside of the vehicle.

14. The solar power system and control of claim 9, wherein the solar power unit includes solar panels which fold and unfold.

15. The solar power system and control of claim 9, further including a bracket for mounting the electric drive motor to the vehicle.

16. The solar power system and control of claim 9, wherein:
the user interface includes a system deactivate user input configured to generate and transmit a system deactivate signal;
the thermostat controller is configured to disconnect electric power connections from the input port to the output ports configured to be connected to the electric drive motor, the condenser fan electric motor, and the blower fan electric motor, at least in part, in response the deactivate system signal.

17. A method of installing a vehicle air conditioning solar power and control system on a vehicle, the air conditioning system including a compressor, a condenser with a condenser fan electric motor, and a blower fan with a blower fan electric motor, the vehicle including a power storage device, comprising:
disconnecting the compressor from a motive power source of the vehicle;
mounting an electric drive motor, a solar power unit including a voltage regulator, and a thermostat controller to the vehicle; the solar power unit configured to convert solar energy to DC electric power at a predefined voltage; the thermostat controller including a power interface with a battery input port, an electric drive motor output port, a condenser fan electric motor output port, and a blower fan electric motor output port;
drivingly connecting the electric drive motor to the compressor;
electrically connecting the solar power unit to the power storage device;
electrically connecting the power storage device input port to the power storage device;
electrically connecting the compressor output port to the electric drive motor;
electrically connecting the condenser fan electric motor output port to the condenser fan electric motor; and
electrically connecting the blower fan electric motor output port to the blower fan electric motor; and
wherein the thermostat controller is configured to electrically connect the battery input port to the electric drive motor output port, the condenser fan electric motor output port, and the blower fan electric motor output port, at least in part, in response to a system activate signal received from a user interface.

18. The method of installing a vehicle air conditioning solar power and control system on a vehicle of claim 17, wherein:
the motive power source of the vehicle includes an internal combustion engine; and
disconnecting the compressor from the internal combustion engine includes removing a belt from a driving connection between the internal combustion engine and the compressor.

19. The method of installing a vehicle air conditioning solar power and control system on a vehicle of claim 17,
wherein the user interface is a component of a remote control device; and
further including communicatively connecting the remote control device to the thermostat controller to receive the system activate signal.

20. The method of installing a vehicle air conditioning solar power and control system on a vehicle of claim 17,
wherein the user interface is a component of a personal electronic device; and
further including communicatively connecting the personal electronic device to the thermostat controller through a communication network to receive the system activate signal.
